(19) United States
(12) Patent Application Publication
(10) Pub. No.: US 2017/0148087 A1
(43) Pub. Date: May 25, 2017

(54) VIRTUAL CHECKOUT COUNTER SYSTEM AND METHOD

(71) Applicant: Aintu Inc., San Jose, CA (US)

(72) Inventor: Arthur Vaysman, San Jose, CA (US)

(21) Appl. No.: 15/284,502

(22) Filed: Oct. 3, 2016

Related U.S. Application Data
(60) Provisional application No. 62/236,107, filed on Oct. 1, 2015.

(51) Int. Cl. G06Q 30/06; G06K 7/14; G06K 7/10

(52) U.S. Cl. CPC G06Q 30/0635; G06K 7/10722; G06K 7/1413

(57) ABSTRACT

A system to implement the virtual checkout service is disclosed. The system comprises comprising: a virtual checkout server configured to implement the virtual checkout service; a user computing device configured to communicate with said virtual checkout server as the user shops within a physical store; and a retailer device associated with said physical store to communicate with said virtual checkout server in order to verify purchases by said user.

### TECHNICAL FIELD

Embodiments of the present disclosure relate generally to shopping systems, and in more particularly checkout systems.

### BACKGROUND

When shopping at a store, it is commonplace to have a checkout counter generally located at the front of the store. Typically, the checkout counter is equipped with at least one point of sale (POS) device such as a cash register. At the checkout counter, a customer's items for purchase are scanned into the POS device and the individual items are added to produce a total amount due. The consumer then pays the total amount due, whereupon a receipt of the items purchased is printed and given to the customer.

In some cases, at a security checkpoint near the exit entrance to the store, the customer is expected to present the receipt to security personnel who then check to see that the customer does not have items in his/her shopping cart that are not on the printed receipt, a condition indicative of theft.

In view of the above, there is a need for Embodiments of the present invention disclose techniques and systems to enable the purchasing of items at a store by means of a Virtual Checkout Counter (VCC), without the need of an explicit or physical checkout counter.

### SUMMARY

In accordance with an embodiment of the present disclosure, a method for facilitating shopping in a physical retail store, by a user computing device, is disclosed. The method comprises: configuring the user computing device to perform a scan of each item as said item is selected for purchase by the user at any point within the retail store; responsive to said scan, generating scan data and transmitting same to a virtual checkout server; maintaining, by the virtual checkout server, a purchase list comprising items the user has purchased; upon completion of shopping, enabling said user, through the use of said user computing device to initiate a transaction wherein payment for the items on the purchase list is made; and transmitting by the virtual checkout server, a token to the user computing device to uniquely identify said transaction; enabling the user computing device to transmit said token to a retailer device associated with the retail store, to enable verification of payment.

It will be appreciated that features of the present disclosure are susceptible to being combined in various combinations without departing from the scope of the present disclosure as defined by the appended claims.

### BRIEF DESCRIPTION OF THE DRAWINGS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

The present invention, in accordance with one or more various embodiments, is described in detail with reference to the following figures. The drawings are provided for purposes of illustration only and merely depict exemplary embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a deployment scenario for a virtual checkout service, in accordance with one embodiment of the invention;

FIGS. 2, 3A, 3B, 4 and 5 illustrate the steps in a shopping process, in accordance with one embodiment of the invention;

FIG. 6 shows a high-level block diagram of hardware for to implement the virtual checkout server, in accordance with one embodiment of the invention

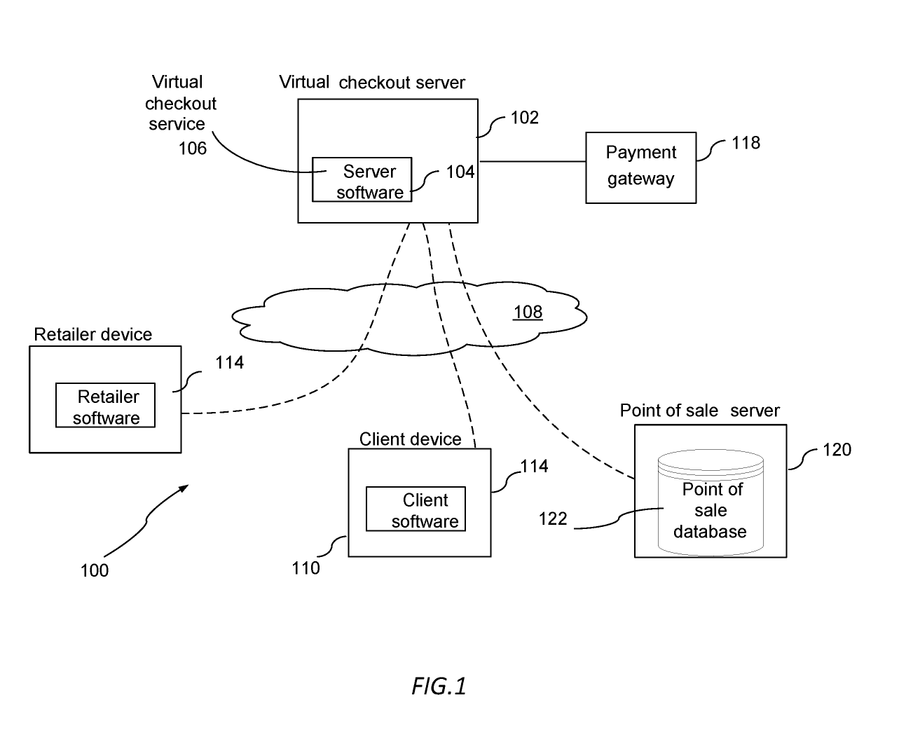

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The virtual check out system 100 includes a virtual check out server 102 provisioned with a server software 104 to implement a virtual check out service.

In one embodiment, the server 102 is deployed as a cloud-based server and may comprise a single server, or a plurality of cloud-based computing resources acting in concert to simulate a single server. The server software 104 may comprise a single application or a plurality of applications distributed across multiple computing resources.

In use, a plurality of client devices 110 establish real-time connections with the server 102 over a network 108. Typically, the client devices 110 may comprise mobile phones of shoppers, and the network 108 may comprise a cellular network which provides data connectivity between the client devices 110 and the server 102. Each of the client devices 110 may be provisioned with client software 112 is to enable a virtual check checkout process, as will be described later.

In one embodiment, the system configuration 100 also includes a plurality of retailer devices 114 that are able to communicate with the server 102 during the virtual checkout process, as will be explained later. The communications between the retailer devices 114 and the server 102 may be facilitated by a cellular network configured to support data communications. In one embodiment, the cellular network may be similar to the network 108. Each retailer device may comprise a mobile device such as a tablet computer provisioned with a retailer software 116 configured to facilitate the virtual check out process, as will be explained.

The system configuration 100 also includes a payment gateway 118 to facilitate payments on behalf of a customer as will be explained later. To facilitate is real time look-up of point of sale data required for the virtual check out a process. In one embodiment, the server 102 may maintain a real-time connection with a point of sale server 120. The point of sale server 120 may be configured with a point of sale database 122 comprising the point of sale data. In one embodiment, the point of sale server 120 may be the server of a vendor such as SAP, or it may be a server of an operator of the virtual check out service disclosed herein.

In one embodiment, each consumer that uses the virtual check service registers with the virtual check out service in order to (a) obtain a customer ID, (b) create login information (e.g. username and password), (c) provision the virtual check out service with at least one valid payment source/mechanism. For example, the payment mechanism may include banking information relating to one or more bank accounts held by the customer. In one embodiment, the virtual check out service may validate the banking information of the customer, using known techniques.

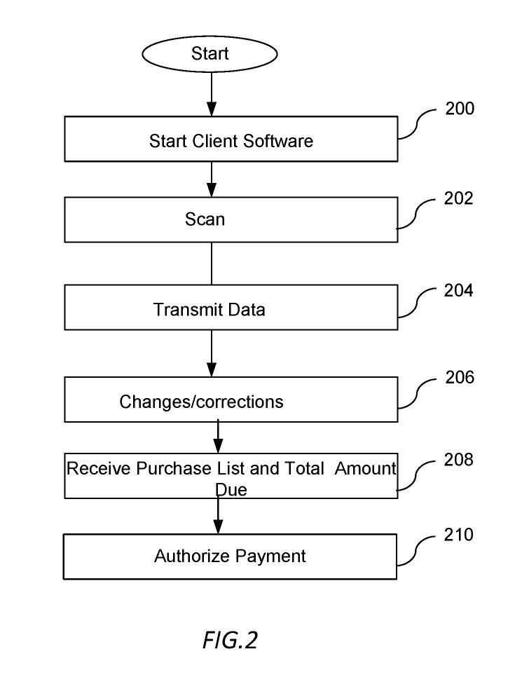

In one embodiment, the virtual checkout process is preceded by a shopping phase. The steps corresponding to the shopping phase, in accordance with one embodiment of the invention, are shown in FIG. 2 the drawings. Referring to FIG. 2, in order to initiate the shopping phase, a customer while at a retail store starts or launches the client software 112. This is indicated by reference 200 in FIG. 2 For example, assume that the customer is at a Costco branch. In this case, this customer will start the client software 112 while at Costco branch. In accordance with some embodiments, an interface of the client software 112 may allow the customer to select the retailer from a drop down list of retailers. For example, in one embodiment, the drop down list of retailers may be generated based on location data (GPS location information) associated with a client device 110 of the customer. In a simpler case, the customer may include information to identify the retailer. For example, in the latter case, the customer may input “Costco, Sunnyvale, 95086” to identify the retailer.

Once the retailer has been correctly identified, the software 112 executes block 202 wherein a “scan” is performed. To initiate the scan, the customer activates a “scan” button in the user interface of the client software 112. Responsive to the activation of the scan button, the software 112 turns on a camera of the client device 110 so that said camera is ready to capture an image. Simultaneously, in one embodiment, an onscreen viewfinder of the client device 110 may be activated to assist the customer to compose an image corresponding to a barcode label associated with an item to be purchased. The customer is then expected to select a “capture” button, whereupon the camera captures an image of the bar code. This completes the scan block 202.

At block 204, the software 112 transmits scan data to the server 102 via the network 108. In one embodiment, in order to validate the scan data so that it may be processed by the server 102, an authentication step is performed in order to authenticate the customer to the server 102. As one of ordinary skill in the art would appreciate, said authentication step may comprise transmission of valid login information to the server 102. In accordance with various embodiments, the authentication step may be performed immediately before the data transmission step 204, or even earlier.

In one embodiment, the scan data may comprise images of bar codes. Alternatively, the client software 112 may be provisioned with a bar code reader, whereby the software 112 is able to extract bar codes from barcode images. Thus, in some embodiments, the data that is transmitted in block 204 comprises the barcodes themselves. The scan data may be transmitted serially after each scan is performed, or as a batch.

In one embodiment, the software may be configured to provide the customer with a running list of items that have been scanned. At block 206, the software 112 allows the customer to make changes to said running list by deleting items already scanned, or updating quantities for a scan item. Any changes made by the customer are transmitted to the server 102 in a manner already described. The server 102 may be configured to maintain a purchase list for the customer. Said purchase list comprises the items the customer wishes to purchase.

In one embodiment, to signify that the customer with a button to indicate that the customer wishes to engage in a checkout process, software 112 may include a “checkout” button. Selection of the checkout button, in accordance with one embodiment, would cause the software 112 to transmit a notification to a server 102 to initiate a checkout process, as will be described. For now, suffice it to say that as part of the checkout process, the server 102 maintains a Final Purchase List and the Total Amount Due. The latter two items are received from the server 102 by the software 112 at block 208, in accordance with one embodiment.

At this stage, in one embodiment, client software 112 executes an authorize payment block 210. For example, the customer views the Final Purchase List, and the Total Amount Due on screen and, if satisfied, selects an “authorize payment” button in the user interface of the software 112. In some cases, the authorize payment button may be associated with a single payment source, such as a credit card. Alternatively, they may be multiple payment sources available, in which case the customer may be allowed to select a payment source. The authorize payment block to 10 may be configured to transmit an “authorize payment message” to the server 102 via the network 108. Said authorize payment message may include the selected payment source.

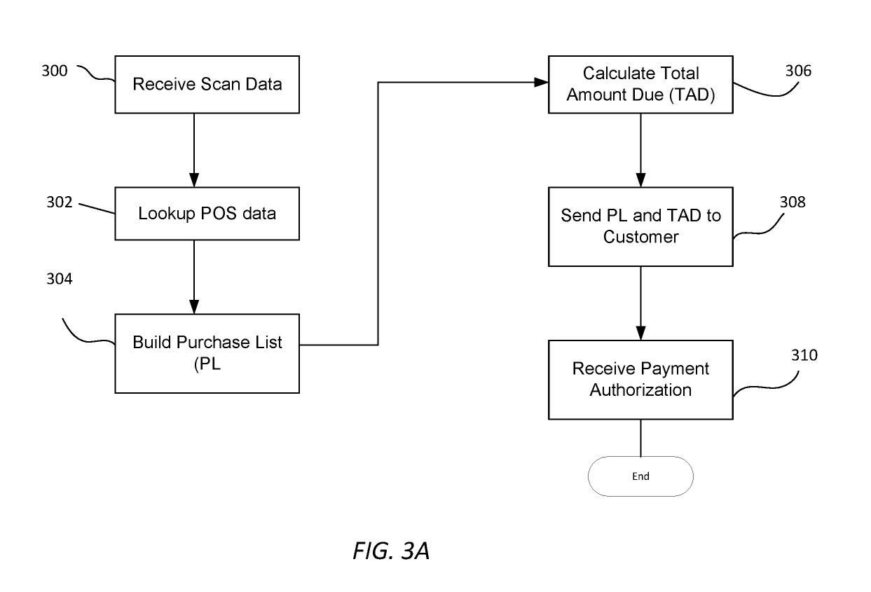

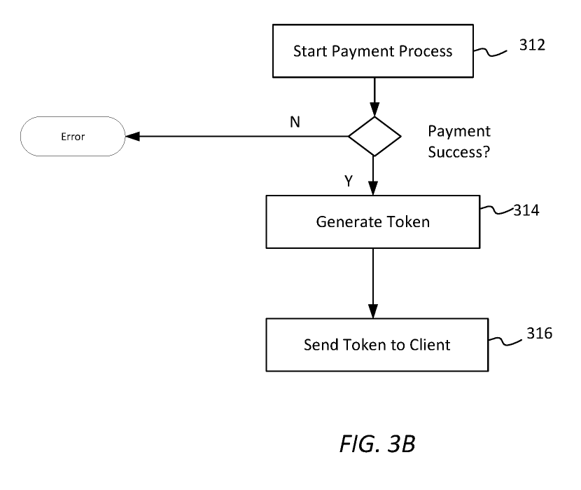

Referring now to FIG. 3A of the drawings, processing steps performed by the server 102 as part of the virtual check the process in accordance with one embodiment are shown. As will be seen, at block 300, the server 102 the receives the scan data from the client device 110. As noted, the scan data may comprise serial items. The scan data may also comprise barcode label images. Regardless of the nature of the scan data, the server software 104 is configured to process the scan data in to a form comprising bar codes. At block 302, a look-up POS data is performed. In one embodiment said look-up is performed based on that point of sale database 122. In this regard, it is to be noted that the point of sale database 122 is provisioned with a point of sale data corresponding to the retailer. The point of the look-up is to obtain pricing information, and product information based on the barcode.

In one embodiment, based on information received by performing the look-ups, the server software 104 builds a Purchase List. This is indicated by the block 304. At block 306, the server software order for calculates the Total Amount Due. The Purchase List and the Total Amount Due are transmitted to the client device 110, at the block 308. At block 310, the server software one of four receive the payment authorization message described above.

Referring now to FIG. 3B of the drawings, at block 312 a payment processes started. In accordance with one embodiment, the payment process includes passing information to the payment gateway 118 in order to transfer the Total Amount Due to the payment source indicated in the payment authorization message to a vendor/retailer bank account, i.e. the bank account of Costco in the present case. If the payment gateway 118 indicates that the payment was successful, then at block 316 the server software 104 generate a token which may be a unique number associated with the purchasing transaction. At block the 16, the unique token is transmitted to the client device 110.

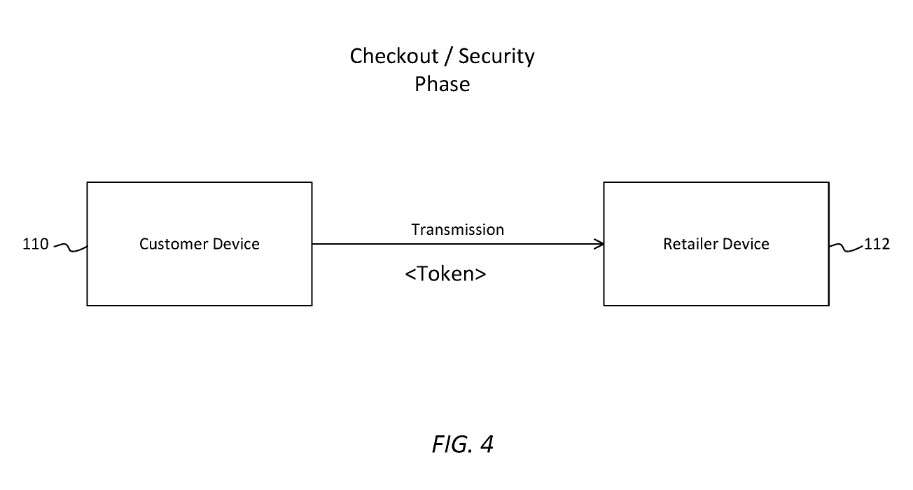

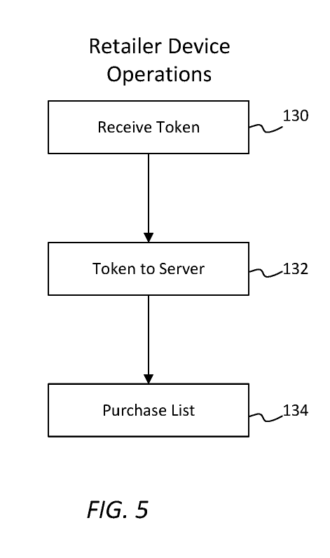

At this point, the customer makes his/her way to the store exit. At the exit, it will be a security checkpoint at which a security officer equipped with a retailer device 114 will engage in a security process, which will now be described. The goal of the security process is to ensure that the customer only has those items in his/her shopping cart for which payment has been made. In one embodiment, to begin the security process, the token received from the server software 104 is transmitted from the customer device 110 to the retailer device 114, as shown in FIG. 4 for the drawing. In one embodiment, to initiate the transmission of the token, the customer selects a “transmit” button provided in the user interface of the client software 112. In response to selection of the transmit button, in one embodiment, the token is encoded into an audio signal by the client software 112 and is transmitted using a speaker of the customer device 110. The transmission is detected by a microphone associated with the retailer device 114. This step is indicated by reference 130 in FIG. 5, wherein the token is received by the retailer device. In one embodiment, the retailer device is configured to decode the transmission in order to recover the token. To complete the security process, the retailer device 114 transmits the token to the server device 102, as indicated by reference 132. The server device 12 is configured to authenticate the retailer device 114 and to transmit the Purchase List associated with the token/transaction to the retailer device 114. Referring to FIG. 5, reference numeral 134 indicates receipt of the purchase list by the retailer device. Advantageously, the retailer device 114 may be configured to display the Purchase List on screen thereby to enable the security officer to verify that the shopping cart only contains items that have been purchased.

In one embodiment, in order to encode the token into the audio signal, techniques disclosed in co-pending U.S. patent application Ser. No. 14/714,127 entitled “Technique for Encoding Digital Information in a Carrier Wave”, which is incorporated herein by reference, may be used.

In some cases, if retailer may loan client devices 110 to customers for use in accordance with the techniques disclosed herein. For example, using a loan client device 110 may be beneficial in a case where a customer does not have a smart phone, or as a smart phone that is running low on battery.

In one embodiment, shopping cart software retailer may include an embodiment of a client device 110 for use by customers. For example, a shopping cart may have a holder to hold a client device 110. In one embodiment, the client device 110 provided with a shopping cart may be a dumbed-down or single application mobile phone.

In some cases, a retailer may provide a kiosk comprising a printer. In use, a customer connects his/her client device 110 to the printer, for example by means of a wireless connection, in order to print or a receipt evidencing the items purchased, in accordance with the techniques disclosed herein. Advantageously said receipt may be presented at the security checkpoint.

Embodiments of the present invention disclose techniques and systems to enable the purchasing of items at a store by means of a Virtual Checkout Counter (VCC), without the need of an explicit or physical checkout counter.

The features/functions of the technology described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures. Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

A computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database module might include other similar instrumentalities for allowing computer programs or other instructions or data to be loaded into computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

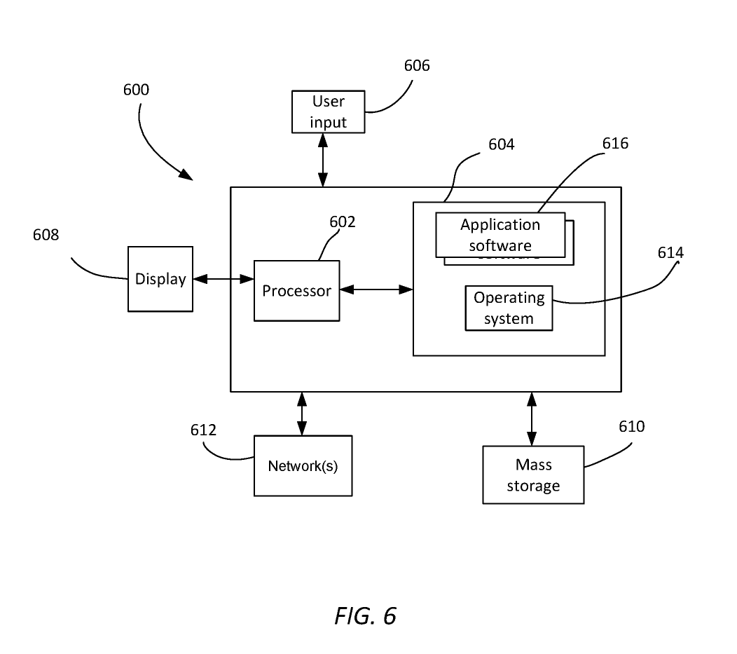

FIG. 6 shows an example of hardware 600 that may be used to implement the server device 102 in accordance with one embodiment. The hardware 600 may include at least one processor 602 coupled to a memory 604. The processor 602 may represent one or more processors (e.g., microprocessors), and the memory 604 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 604 may be considered to include memory storage physically located elsewhere in the hardware, e.g. any cache memory in the processor 602, as well as any storage capacity used as a virtual memory, e.g., as stored on a mass storage device.

The hardware also typically receives a number of inputs and outputs for communicating information externally. For interface with a user or operator, the hardware may include one or more user input output devices 606 (e.g., a keyboard, mouse, etc.) and a display 608. For additional storage, the hardware 600 may also include one or more mass storage devices 410, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 612 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 612 and each of the components, as is well known in the art.

The hardware 600 operates under the control of an operating system 614, and executes application software 616 which includes various computer software applications, components, programs, objects, modules, etc. to perform the techniques described above.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for facilitating shopping in a physical retail store, by a user computing device, the method comprising:
configuring the user computing device to perform a scan of each item as said item is selected for purchase by the user at any point within the retail store;
responsive to said scan, generating scan data and transmitting same to a virtual checkout server;
maintaining, by the virtual checkout server, a purchase list comprising items the user has purchased;
upon completion of shopping, enabling said user, through the use of said user computing device to initiate a transaction wherein payment for the items on the purchase list is made; and transmitting by the virtual checkout server, a token to the user computing device to uniquely identify said transaction;
enabling the user computing device to transmit said token to a retailer device associated with the retail store, to enable verification of payment.

2. The method of claim 1, wherein enabling the user computing device to transmit said token to the retailer device comprises encoding the token and transmitting same through a speaker of the user computing device.

3. The method of claim 1, wherein enabling the user computing device to perform a scan comprises activating a camera associated with the user computing device in order to capture a bar code label associated with the item.

4. The method of claim 3, wherein said scan data comprises an image of the bar code label.

5. The method of claim 3, wherein said scan data comprises derivative data obtained from the bar code label.

6. The method of claim 1, further comprising performing an authentication step in order to authenticate the user to the virtual checkout server as a registered user of a virtual checkout counter service provided by the virtual checkout service.

7. The method of claim 6, wherein to enable said payment, the virtual checkout server maintains payment information on behalf of the user.

8. The method of claim 7, wherein said payment information comprises information to enable the virtual checkout server to process the payment through a payment gateway.

9. The method of claim 1, wherein for verification of payment, said retailer device is configured to transmit the token to the virtual checkout server.

10. The method of claim 9, wherein responsive to receiving the token from the retailer device, said virtual checkout server transmits a list of the items purchased by the user to the retailer device in order that an operator of said retailer device may visually inspect a shopping cart associated with the user in order to verify that only items that have been purchased are in the cart.

11. A system, comprising:
a virtual checkout server configured to implement a virtual checkout service;
a user computing device configured to communicate with said virtual checkout server as the user shops within a physical store; and
a retailer device associated with said physical store to communicate with said virtual checkout server in order to verify purchases by said user.

12. The system of claim 11, wherein prior to checkout, the user computing device captures the scans of each item to be purchased, and transmit same to the virtual checkout server to enable the but for checkout server to maintain a list of items purchased.

13. A system of claim 12, wherein the user computing device transmits a signal to the virtual checkout server to denote that the user wishes to effect payment for the items purchased; whereupon said virtual checkout server computes a purchase amount corresponding to the items purchased.

14. The system of claim 13, wherein the user computing device transmits a payment signal to enable the virtual checkout server to process payment for the items purchased through a third-party payment gateway.

15. The system of claim 14, wherein said virtual within the checkout server is configured to deposit the payment into an account associated with a retailer operating the physical store.

16. The system of claim 14, wherein the virtual checkout server is configured to provide a token to the user computing device to identify a transaction associated with the items purchased.

17. The system of claim 14, wherein said user computing device is configured to transmit said token to said retailer device prior to the user exiting the store.

18. The system of claim 17, wherein said retailer device is configured to transmit said token to the virtual checkout server.

19. The system of claim 18, wherein said virtual checkout server is configured to transmit a list of the items purchased by the user to the retailer device, in response to receiving the token from the retailer device.
